(19) United States
(12) Patent Application Publication
(10) Pub. No.: US 2022/0344772 A1
(43) Pub. Date: Oct. 27, 2022

(54) Venting Unit and Housing, in Particular Battery Housing

(71) Applicant: MANN+HUMMEL GmbH, Ludwigsburg (DE)

(72) Inventors: Thomas SCHLEIDEN, Oberstenfeld (DE); Oliver Winger, Kirchberg (DE); Martin Ploppa, Stuttgart (DE)

(21) Appl. No.: 17/724,135

(22) Filed: Apr. 19, 2022

(30) Foreign Application Priority Data
Apr. 26, 2021 (DE) 10 2021 110 580.3

(51) Int. Cl. H01M 50/30; H01M 50/342

(52) U.S. Cl. CPC H01M 50/394; H01M 50/3425; H01M 2200/20

(57) ABSTRACT

A venting unit for a housing has a base body to be connected fluid-tightly to an edge of a housing opening of the housing. The base body has an exterior side and an inner side. The base body has a gas passage opening and a rim surrounding it. A membrane areally spans the gas passage opening transversely to an axial direction of the base body. The membrane is connected fluid-tightly to the base body at the rim of the base body and is arranged at the inner side of the base body. A clamping frame is connected to the base body at the inner side in a region radially outside of the rim of the base body. The clamping frame has a circumferentially extending clamping surface exerting a clamping force on the membrane to hold the membrane with friction fit between clamping frame and rim of the base body.

### BACKGROUND OF THE INVENTION

The invention concerns a venting unit for a housing, in particular of a battery, in particular of a traction battery of a motor vehicle, as well as a housing, in particular a battery housing.

Housings for receiving electronic components such as, for example, battery cells and the like, cannot be closed off completely gas-tightly relative to the environment. On the one hand, due to temperature fluctuations, for example, due to heat introduction during charging or discharging of battery cells, and, on the other hand, due to naturally occurring air pressure fluctuations, in particular in mobile systems, a gas exchange between interior and exterior must be enabled. Due to the gas exchange, impermissible mechanical loads of the housing, in particular bursting or bulging of the housing, can be prevented. In addition, in particular in battery housings, an emergency venting function must be present for sudden pressure increase due to failure of the battery cells.

Likewise important is however that the penetration of foreign bodies, dirt, and moisture in form of liquid water is effectively prevented. Therefore, pressure compensation devices are known that comprise semipermeable membranes, for example, of extruded polytetrafluoroethylene (PTFE), that are gas-permeable but liquid-impermeable.

DE 10 2012 022 346 B4 discloses a battery housing that comprises a housing enclosing a housing interior and is provided with a housing opening that is covered by means of a membrane carrier in the form of a housing cover that is provided for venting and for substantially water-tight sealing of the housing interior against ingress of, for example, water, preferably also other liquids. The housing cover comprises a carrier body that comprises a gas passage opening extending continuously between a carrier body inner side and a carrier body outer side for discharging gases or for pressure compensation. The gas passage opening is completely covered by a semipermeable membrane. The carrier body, the membrane, and the housing are airtightly or gas-tightly connected such that substantially no water and preferably also no air or no gas can pass through the housing opening into the housing interior.

### SUMMARY OF THE INVENTION

It is an object of the invention to provide a venting unit for a housing, in particular of a battery, in particular of a traction battery of a motor vehicle, which permits a quick pressure reduction upon occurrence of an excess pressure in the housing.

A further object is to provide a housing, in particular a battery housing, with a venting unit which enables a quick pressure reduction upon occurrence of an excess pressure in the housing.

The aforementioned object is solved according to an aspect of the invention by a venting unit for a housing, in particular of a battery, in particular of a traction battery of a motor vehicle, the venting unit comprising a base body connectable fluid-tightly to an edge of a housing opening of the housing, comprising an exterior side and an inner side, and comprising at least one gas passage opening which is closed by a membrane that is areally spanned across transversely to an axial direction, wherein the membrane is connected fluid-tightly to the base body at a rim surrounding the gas passage opening, and the venting unit further comprising a clamping frame that is connected to the base body at the inner side of the base body in a region that is radially outwardly located relative to the rim surrounding the gas passage opening, wherein the clamping frame comprises a circumferentially extending clamping surface that exerts a clamping force on the membrane so that the membrane is held with friction fit between the clamping frame and the rim of the base body surrounding the gas passage opening.

The further object is solved according to a further aspect of the invention by a housing, in particular a battery housing, in particular of a traction battery of a motor vehicle, for receiving battery cells, which comprises at least one housing wall with a housing opening, wherein the housing opening is closed by a venting unit.

Beneficial configurations and advantages of the invention result from the additional claims, the description, and the drawing.

According to an aspect of the invention, a venting unit for a housing, in particular of a battery, in particular of a traction battery of a motor vehicle, is proposed. The venting unit comprises a base body connectable fluid-tightly to an edge of a housing opening of the housing, comprising an exterior side and an inner side, and comprising at least one gas passage opening which is closed by a membrane that is areally spanned across transversely to an axial direction, wherein the membrane is connected fluid-tightly to the base body at a rim surrounding the gas passage opening. The venting unit further comprises a clamping frame that is connected to the base body at the inner side of the base body in a region that is radially outwardly located relative to the rim surrounding the gas passage opening. In this context, the clamping frame comprises a circumferentially extending clamping surface that exerts a clamping force on the membrane so that the membrane is held with friction fit between the clamping frame and the rim of the base body surrounding the gas passage opening.

The membrane is present at the inner side of the base body. In this manner, the membrane is pressed into its sealing seat in case of excess pressure in the housing and can be brought to burst in a targeted fashion by a burst mechanism, for example, by an emergency venting spike, under defined conditions.

An arrangement of the membrane as well as of the clamping frame at the inner side of the base body comprises the advantage that in this way, on the one hand, the membrane is pressed into its sealing seat in case of an excess pressure in the housing and, on the other hand, the clamping frame is also loaded in the clamping direction by the pressure load. In this way, even under extreme pressure peaks, a safe clamping attachment of the membrane is enabled while, in case of fastening of the clamping frame at the exterior side of the base body, there is the risk that, under a pressure load in the housing, the clamping force acting on the membrane is reduced thereby, which can lead to the membrane becoming detached from its clamping seat.

For the emergency venting of high voltage batteries, usually venting units with permeable PTFE membranes are used. The permeability, which is inter alia the main cost factor for the membrane, is not required for the pure function of emergency venting of the battery. The membrane that takes on only the pressure compensation function can therefore be replaced by a significantly less expensive film with identical burst properties in order to discharge the released gas volume flow in case of a thermal event due to failure of a battery cell.

However, fewest of the films that are suitable for the burst function can be welded to the base body. For fluid-tight fastening of the membrane on the base body, an alternative fastening is therefore proposed.

Advantageously, the membrane is clamped fluid-tightly onto the base body in the venting unit according to the invention. This type of fastening of the membrane can be used in particular when a differing material pairing of membrane film to base body, for example, does not permit welding of the film. Instead of a usually employed expensive PTFE membrane that is welded by means of ultrasonic welding onto the base body, an inexpensive film as a burst membrane can thus be clamped onto the base body.

The membrane is clamped by means of a clamping frame and a seal onto the base body. The application of the clamping force can be realized, for example, by welding, in particular by ultrasonic welding, of the clamping frame to the base body. However, also other connection techniques, for example, snapping-on by means of locking hooks, annular snap-on actions, gluing etc. are conceivable.

With the venting unit according to the invention, cost savings in comparison to the use of PTFE membranes are thus provided.

Advantageously, existing manufacturing devices can be utilized. An existing base body can be used in order to furnish the venting unit with the clamping action of the membrane in accordance with the invention.

The manufacture can be realized with existing and known processes such as, for example, ultrasonic welding. In this way, a flexible solution is provided because, independent of the material pairing, different films can be clamped on the base body.

This solution is applicable for gas-tight pure burst membranes but also for permeable membranes in case they cannot be directly welded to the base body plate.

According to a beneficial embodiment of the venting unit, the membrane can be held exclusively with friction fit between the clamping frame and the rim of the base body surrounding the gas passage opening. In this manner, very different film materials, which cannot be welded in the material pairing with the base body, can be used as burst membranes. In this way, inexpensive solutions for a venting unit can be provided.

According to a beneficial embodiment of the venting unit, the clamping frame can be connected at least in sections thereof by material fusion to the base body. Advantageously, the required clamping force for a fluid-tight connection of the membrane to the base body can be achieved in this way, without material-fusing processes having to be employed.

According to a beneficial embodiment of the venting unit, the clamping force can be introduced directly or indirectly, in particular by a seal, into the membrane. The clamping force can be applied and introduced directly into the membrane by means of the clamping frame. Alternatively, it is also possible that in addition a seal can be provided circumferentially all around which ensures a uniform distribution of the clamping force on the membrane. In addition, a sealing action even of minimal gaps can thus be ensured by the seal.

According to a beneficial embodiment of the venting unit, the seal can be arranged between clamping frame and membrane or between membrane and base body. The seal can thus provide a more uniform clamping force on the membrane so that a reliable fluid-tight connection of the membrane to the base body is ensured. In this way, a permanent sealing action of the gas passage opening in the intended operation of the housing can be achieved.

The seal can be embodied as a conventional elastomer seal or as a liquid seal. The seal can be molded, for example, as a two-component seal, onto the clamping frame or onto the base body. In the form of an elastomer seal, the seal can be provided with a round cross section, for example, in the form of an O-ring, or embodied with rectangular cross section.

According to a beneficial embodiment of the venting unit, the gas passage opening can be covered completely by the membrane. In this way, a permanent sealing action of the gas passage opening in the intended operation of the housing can be achieved. In this way, it can be prevented that dirt particles or moisture can penetrate into the housing and endanger the operation of a high voltage battery, for example.

According to a beneficial embodiment of the venting unit, the membrane can be embodied as a gas-impermeable membrane, in particular as a polymer film, or as a semipermeable membrane which enables a passage of gaseous media from an environment into the housing and in reverse and prevents the passage of liquid media and/or solids.

As a gas-impermeable membrane, for example, non-porous membranes in the form of polymer films can be used. Laminated films but also silver-metallized films can be used in order to ensure the seal-tightness of the housing in the intended operation.

For the semipermeable membrane, all materials can be used which comprise a gas permeability for venting in the normal operation and a sufficiently high water impermeability. As a preferred material for the semipermeable membrane, polytetrafluoroethylene (PTFE) can be used. The semipermeable membrane comprises an average pore size that can lie between 0.01 micrometers and 20 micrometers. The porosity lies preferably at approximately 50%; the average pore size amounts to preferably approximately 10 micrometers.

The membrane thickness of the membrane is very much smaller than its remaining outer dimensions. The membrane can span across a minimum width and/or minimum length or a minimum outer diameter of equal to or larger than 20 mm, preferably of equal to or larger than 30 mm, in particular of equal to or larger than 40 mm. The membrane thickness can be in particular smaller by at least 20 times, preferably at least 40 times, in particular at least 100 times, than the minimum width and/or minimum length or the minimum outer diameter of the membrane. The membrane thickness can amount to 1 micrometer to 5 millimeter, wherein a membrane thickness of 0.1 to 2 mm, in particular 0.15 to 0.5 mm, is preferred.

According to a beneficial embodiment of the venting unit, the clamping frame can be connected to the base body welded, in particular ultrasonic welded, or glued. For example, the clamping frame can be manufactured of the same plastic material as the base body. In this way, beneficial conditions for a material-fused connection, for example, by ultrasonic welding but also gluing, can be provided.

According to a beneficial embodiment of the venting unit, the clamping frame can have a radially projecting flange region and the welding or adhesive connection is realized across its axial surface area. The flange region can advantageously provide sufficient surface area in order to ensure a permanent and reliable connection by welding or gluing of clamping frame and base body. Also, a sufficient space can be provided in order to be able to suitably position the tool, for example, a sonotrode, in particular upon ultrasonic welding.

According to a beneficial embodiment of the venting unit, the clamping surface can be arranged radially inside of the flange region. In this manner, a reliable and permanent fluid-tight connection between membrane and base body can be achieved.

According to a beneficial embodiment of the venting unit, the base body can comprise, in relation to the rim surrounding the gas passage opening at which the membrane is fluid-tightly arranged, an axial recess wherein at this axial recess the clamping frame is arranged material-fused. Such a construction enables a beneficial manufacturing method. In particular, the membrane can be suitably inserted and positioned prior to the clamping frame being connected by material fusion to the base body by means of ultrasonic welding.

According to a beneficial embodiment of the venting unit, the axial recess can be arranged radially outwardly displaced relative to the rim surrounding the gas passage opening. In this manner, a reliable and permanent fluid-tight connection between membrane and base body can be achieved.

According to a beneficial embodiment of the venting unit, the radially projecting flange region and the clamping surface of the clamping frame can be arranged axially displaced. Such a construction enables a beneficial manufacturing method. In particular, the membrane can be suitably inserted and positioned prior to the clamping frame being connected by material fusion to the base body by means of ultrasonic welding.

According to a beneficial embodiment of the venting unit, a housing seal can be arranged so as to circumferentially extend around the gas passage opening at the inner side of the base body.

The housing seal can be embodied as an axial seal or radial seal, i.e., in particular at an end face (in case of the axial seal) or at a circumferential wall surface (in case of the radial seal). The housing seal can be embodied as an O-ring, received in a corresponding groove of the base body, or as molded-on seal component. An arrangement of the housing seal in axial configuration is preferred wherein, particularly preferred, the housing seal surrounds a bayonet connection means which extends in particular in the axial direction.

The housing seal can be embodied in particular also as a shaped seal with a non-circular cross section, in particular stretched in length direction.

According to a beneficial embodiment of the venting unit, a cover can be arranged at the exterior side of the base body. In particular, the cover can have at least one venting opening. The cover protects the membrane from mechanical actions from the exterior side of the base body. At the same time, a gas escape, for example, through venting openings or by a sufficient spacing between cover and base body, can be enabled.

According to a beneficial embodiment of the venting unit, a spike carrier with an emergency venting spike oriented toward the membrane can be arranged between the membrane and the cover and is provided for penetration of the membrane that is bulging in the direction toward the exterior side due to a housing inner pressure, wherein the emergency venting spike can be integrated in the base body or in the clamping frame or in the cover.

The emergency venting spike is arranged at a predetermined distance to the membrane surface in the normal operation of the battery. With increasing inner pressure in the housing, the membrane bulges toward the emergency venting spike and contacts it so that the tip of the emergency venting spike can penetrate the membrane. Due to its tip, the emergency venting spike produces a targeted weakening of the membrane so that the latter ruptures. This serves for ensuring an emergency venting function that reacts as quickly as possible, which is important in order to be able to ensure that the housing structure remains intact in case of a sudden inner pressure increase in the housing. Due to a variation of the distance of the tip of the emergency venting spike from the membrane surface, the emergency venting pressure is adjustable.

According to a beneficial embodiment of the venting unit, the base body can be fixedly connected to a protective grid arranged at its inner side. In particular, the protective grid can be integrated in the base body in this context. Due to the protective grid, the membrane is protected from mechanical damages from the interior. On the other hand, due to the protective grid it is also ensured that, in case of a failure of a battery cell in the battery housing and a thermal event that is possibly caused thereby, particles that have a greater expansion than a mesh width of the protective grid remain in the interior of the housing and cannot reach the environment.

According to a further aspect of the invention, a housing, in particular a battery housing, in particular of a traction battery of a motor vehicle, for receiving battery cells, is proposed that comprises at least one housing wall with a housing opening, wherein the housing opening is closed by a venting unit according to the invention.

In particular, mounting of the venting unit is provided in this context such that the latter by means of at least one fastening means, in particular a screw, is connected to a wall of the housing, wherein the fastening means is in engagement with the fastening means engagement region of the base body. Due to the screw action, the sealing pretension forces are generated which are required for compression of the housing seal. The screw action can be in particular realized from an interior of the electronics housing. Of course, embodiments of the invention are encompassed also in which the screw action of the venting unit with the housing is realized from the exterior side.

Finally, the housing wall can comprise at an exterior side a seal surface surrounding the housing opening at which the housing seal of the venting unit is resting in a mounted state. The seal surface is preferably embodied as a region of the wall of the housing with deviations as minimal as possible with regard to flatness and minimal roughness. Beneficially, the housing or at least its wall comprises or is comprised of a metal material so that the seal surface can be obtained simply by mechanical machining with respect to the aforementioned properties.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will expediently consider the features also individually and combine them to further expedient combinations. The Figures show embodiments in exemplary fashion.

FIG. 1 shows an isometric view of a venting unit according to an embodiment of the invention from an exterior side.

FIG. 2 shows an isometric view of the venting unit according to FIG. 1 from an inner side.

FIG. 3 shows the isometric view from the inner side of the venting unit according to FIG. 1 with removed protective grid.

FIG. 4 shows an isometric section view of the venting unit according to FIG. 1 with the base body in half-section.

FIG. 5 shows the isometric section view according to FIG. 4 of the venting unit with sectioned seal.

FIG. 6 shows a longitudinal section through the venting unit according to FIG. 1.

FIG. 7 shows an enlarged longitudinal section of the venting unit according to FIG. 1 in the region of the clamping action of the membrane.

### DESCRIPTION OF PREFERRED EMBODIMENTS

In the Figures, same or same-type components are identified with same reference characters. The Figures show only examples and are not to be understood as limiting.

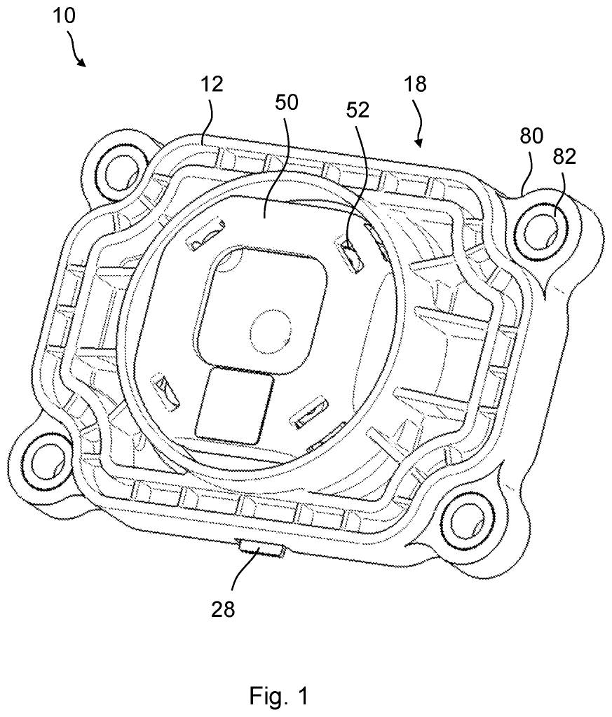

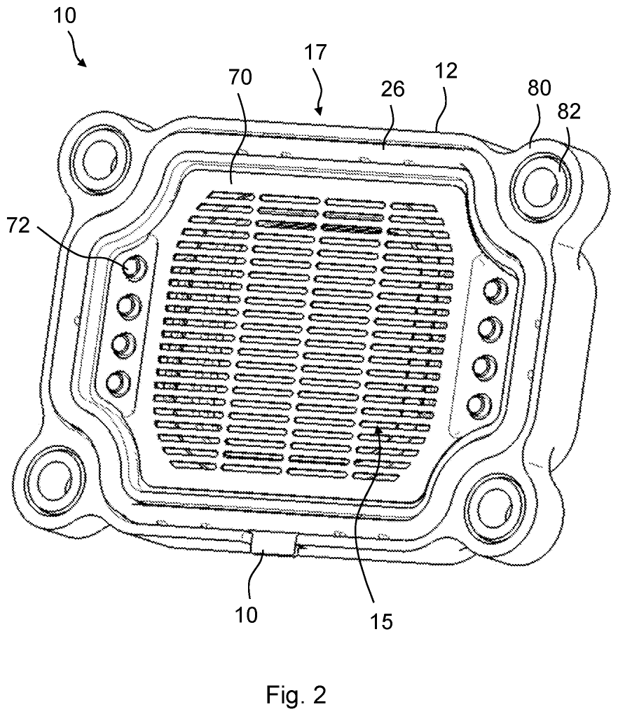

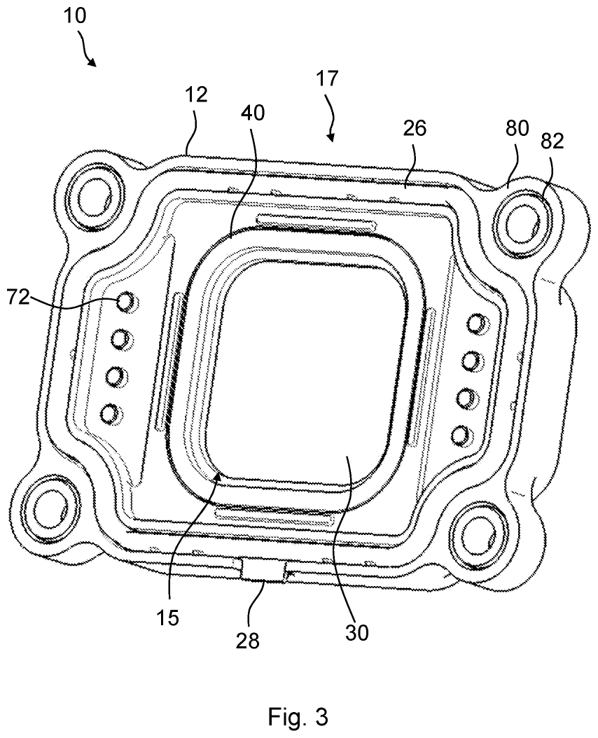

FIG. 1 shows an isometric view of a venting unit 10 for a housing 20, in particular of a battery, in particular of a traction battery of a motor vehicle, according to an embodiment of the invention from an exterior side 18 while in FIG. 2 an isometric view of the venting unit 10 from an inner side 17 can be seen. FIG. 3 shows the isometric view of the venting unit 10 from the inner side 17 with removed protective grid 70.

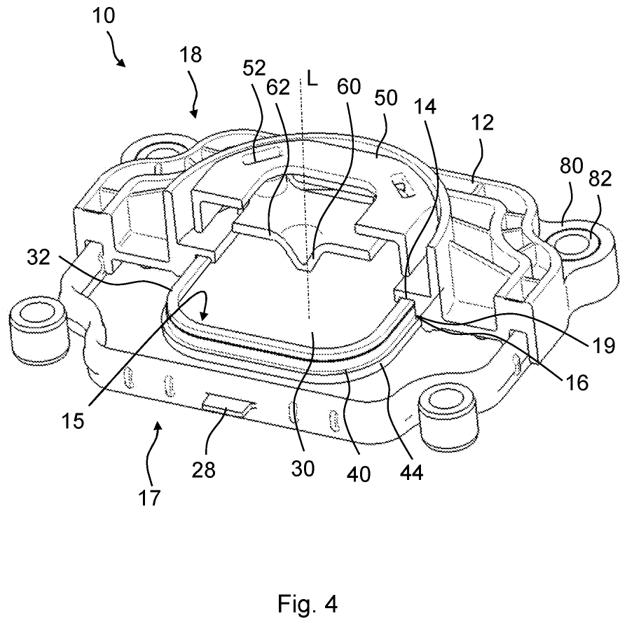

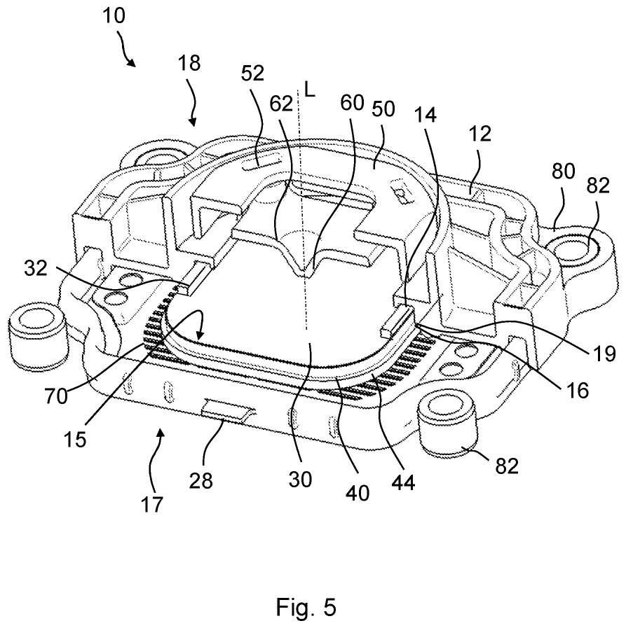

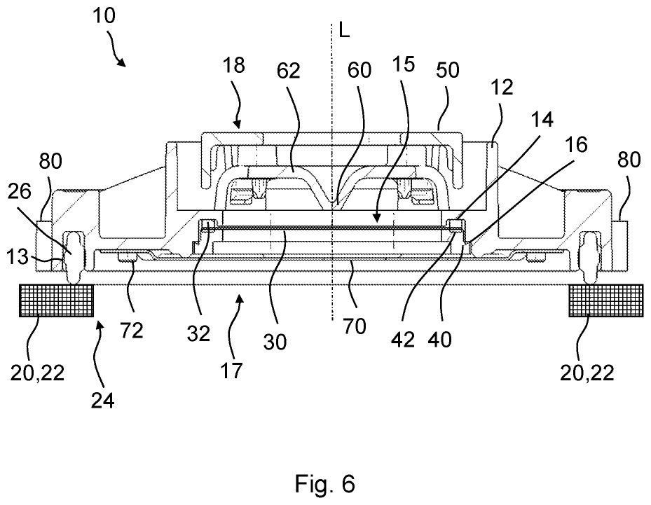

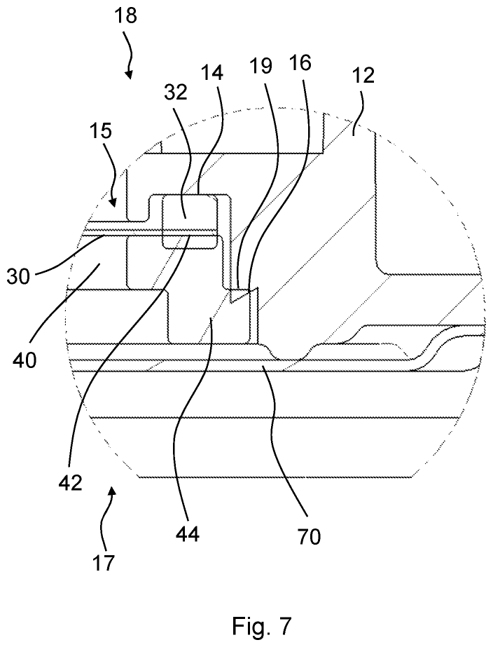

Details of the venting unit 10 can be seen in FIG. 4 with an isometric section view with half-sectioned base body 12 as well as in FIG. 5 with an isometric section view with sectioned seal 32, In FIG. 6, a longitudinal section of the venting unit 10 is illustrated. FIG. 7 shows in this context an enlarged longitudinal section of the venting unit 10 in the region of the clamping action of the membrane 30.

The venting unit 10 comprises a base body 12, with an exterior side 18 and an inner side 17, that can be connected fluid-tightly to an edge of a housing opening 24 of the housing 20 (schematically illustrated in FIG. 6 in longitudinal section).

The venting unit 10 comprises moreover a gas passage opening 15 (see FIG. 6) which is closed by a membrane 30 that is areally spanned across transversely to an axial direction L. The gas passage opening 15 is covered completely by the membrane 30 in this context. The membrane 30 is located at the inner side 17 of the base body 12.

The membrane 30 is fluid-tightly connected to the base body 12 at the rim 14 surrounding the gas passage opening 15.

The membrane 30 can be embodied as a gas-impermeable membrane, in particular as a polymer film.

Alternatively, it is however also possible that the membrane 30 is embodied as a semipermeable membrane which enables a passage of gaseous media from an environment into the housing 10 and in reverse and prevents the passage of liquid media and/or solids.

A clamping frame 40 is connected to the base body 12 in a region 16 that is located radially outwardly of the rim 14 surrounding the gas passage opening 15. The clamping frame 40 comprises a circumferentially extending clamping surface 42 that exerts a clamping force on the membrane 30. In this way, the membrane 30 is held exclusively with friction fit between the clamping frame 40 and the rim 14 of the base body 12 surrounding the gas passage opening 15.

The clamping frame 40 is connected by material fusion to the base body 12. Preferably, the clamping frame 40 can be welded to the base body, in particular by ultrasonic welding. However, also other fastening types such as locking or gluing to the base body 12 are conceivable.

The clamping force is introduced in the illustrated embodiment indirectly by a seal 32 into the membrane 30. In this way, a more uniform clamping force across the clamping surface 42 is achieved. Alternatively, the membrane 30 can also be clamped directly by the clamping frame 40 against the base body 12.

In this case, the seal 32 is arranged between membrane 30 and base body 12. Alternatively, it is also possible that the seal 32 is arranged between the clamping frame 40 and the membrane 30.

At the exterior side 18 of the base body 12, a cover 50 is arranged which comprises four venting openings 52.

Between the membrane 30 and the cover 50, a spike carrier 62 is arranged with an emergency venting spike 60 which is provided for penetrating the membrane 30 which bulges in the direction toward the exterior side 18 due to a housing inner pressure. The emergency venting spike 60 in this embodiment is integrated via the spike carrier 62 in the base body 12. Alternatively, the emergency venting spike 60 can also be integrated in the clamping frame 40 or in the cover 50.

The base body 12 is fixedly connected to a protective grid 70 arranged at its inner side 17, as is illustrated in particular in FIG. 2. In this context, the protective grid 70 is welded by weld points 72 to the base body 12, for example, by ultrasonic welding. In an alternative embodiment, the protective grid 70 can also be integrated directly in the base body 12 however.

The base body 12 comprises moreover at its corners four fastening lugs 80 in which insertion sleeves 82 are integrated. By means of these fastening lugs 80, the venting unit 10 can be connected to the housing 20, for example, screwed on.

A housing seal 26 (FIGS. 2 and 3) is arranged so as to extend circumferentially about the gas passage opening 15 at the inner side 17 of the base body 12 and serves for sealing the venting unit 10 against the housing wall 22. A control regarding the presence of the housing seal 26 when the venting unit 10 is mounted is provided by the external conspicuous visible tab 28 of the housing seal 26.

As can be seen in the longitudinal sections in FIG. 6 and in particular in FIG. 7, the clamping frame 40 comprises a radially projecting flange region 44 and the welding or gluing action to the region 16 of the base body 12 is realized across its axial surface. In this context, the clamping surface 42 of the clamping frame 40 is radially inwardly arranged relative to the flange region 44. The radially projecting flange region 44 and the clamping surface 42 of the clamping frame 40 are arranged axially displaced.

The base body 12 comprises an axial recess 19 in relation to the rim 14 surrounding the gas passage opening 15 at which the membrane 30 is fluid-tightly arranged. At this axial recess 19, the clamping frame 40 is arranged material-fused. The axial recess 19 is displaced radially outwardly relative to the rim 14 surrounding the gas passage opening 15.

In the longitudinal section in FIG. 6, a part of the housing 20 is illustrated schematically as a housing wall 22 with a housing opening 24. The housing opening 24 is closed by the venting unit 10 in this context.

The venting unit 10 is sealed against the housing wall 22 with the housing seal 26 which is inserted into a circumferentially extending sealing groove 13 at the outer edge of the base body 12.

### REFERENCE CHARACTERS

10 venting unit
12 base body
13 sealing groove
14 rim
15 gas passage opening
16 region
17 inner side
18 exterior side
19 axial recess
20 housing
22 housing wall
24 housing opening
26 housing seal
28 visible tab of housing seal
30 membrane
32 seal
40 clamping frame
42 clamping surface
44 flange region
50 cover
52 venting opening
60 emergency venting spike
62 spike carrier
70 protective grid
72 weld point
80 fastening lug
82 insertion sleeve
L axial direction

What is claimed is:

1. A venting unit for a housing, the venting unit comprising:
a base body configured to be connected fluid-tightly to an edge of a housing opening of the housing, wherein the base body comprises an exterior side and an inner side, wherein the base body further comprises at least one gas passage opening and a rim surrounding the at least one gas passage opening;
a membrane areally spanned across the at least one gas passage opening transversely to an axial direction of the base body, wherein the membrane is connected fluid-tightly to the base body at the rim of the base body, and wherein the membrane is arranged at the inner side of the base body;
a clamping frame connected to the base body at the inner side of the base body in a region located radially outside of the rim of the base body;
the clamping frame comprising a circumferentially extending clamping surface configured to exert a clamping force on the membrane to hold the membrane with friction fit between the clamping frame and the rim of the base body.

2. The venting unit according to claim 1, wherein the membrane is held exclusively with friction fit between the clamping frame and the rim of the base body.

3. The venting unit according to claim 1, wherein the clamping frame is connected at least in regions thereof with material fusion to the base body.

4. The venting unit according to claim 1, wherein the clamping force is introduced directly into the membrane.

5. The venting unit according to claim 1, wherein the clamping force is introduced indirectly into the membrane.

6. The venting unit according to claim 1, wherein the clamping force is introduced indirectly into the membrane by a seal.

7. The venting unit according to claim 6, wherein the seal is arranged between the clamping frame and the membrane or is arranged between the membrane and the base body.

8. The venting unit according to claim 1, wherein the at least one gas passage opening is covered completely by the membrane.

9. The venting unit according to claim 1, wherein the membrane is a gas-impermeable membrane.

10. The venting unit according to claim 9, wherein the gas-impermeable membrane is a polymer film.

11. The venting unit according to claim 1, wherein the membrane is a semipermeable membrane that enables a passage of gaseous media from an environment into the housing and in reverse and that prevents a passage of liquid media and/or solids therethrough.

12. The venting unit according to claim 1, wherein the clamping frame is welded or glued to the base body.

13. The venting unit according to claim 1, wherein the clamping frame comprises a radially projecting flange region comprising an axial surface, wherein the clamping frame is welded or glued to the base body across the axial surface of the radially projecting flange region.

14. The venting unit according to claim 13, wherein the clamping surface is arranged radially inside of the radially projecting flange region.

15. The venting unit according to claim 13, wherein the radially projecting flange region and the clamping surface of the clamping frame are arranged axially displaced relative to each other.

16. The venting unit according to claim 1, wherein the base body comprises an axial recess in relation to the rim of the base body, wherein the clamping frame is material-fused to the axial recess.

17. The venting unit according to claim 16, wherein the axial recess is arranged displaced radially outwardly in relation to the rim of the base body.

18. The venting unit according to claim 1, further comprising a housing seal arranged at the inner side of the base body and circumferentially surrounding the at least one gas passage opening.

19. The venting unit according to claim 1, further comprising a cover arranged on the exterior side of the base body, wherein the cover comprises at least one venting opening.

20. The venting unit according to claim 1, further comprising a spike carrier arranged between the membrane and the cover, wherein the spike carrier comprises an emergency venting spike oriented toward the membrane, wherein the emergency venting spike is configured to penetrate the membrane when the membrane bulges in the direction toward the exterior side due to a housing inner pressure.

21. The venting unit according to claim 20, wherein the emergency venting spike is integrated in the base body or integrated in the clamping frame or integrated in the cover.

22. The venting unit according to claim 1, further comprising a protective grid arranged at the inner side of the base body, wherein the base body is fixedly connected to the protective grid or the protective grid is integrated in the base body.

23. A housing comprising:
at least one housing wall with a housing opening;
the venting unit according to claim 1 arranged at the least one housing wall and closing the housing opening.
